(19) United States
(12) Patent Application Publication
(10) Pub. No.: US 2007/0139408 A1
(43) Pub. Date: Jun. 21, 2007

(54) Reflective image objects

(75) Inventor: Jaakko Keranen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/313,279

(22) Filed: Dec. 19, 2005

(51) Int. Cl. G06T 15/50

(52) U.S. Cl. 345/426

(57) ABSTRACT

A method of computer graphics is shown for rendering reflections on surfaces of a three-dimensional object. An environment image to be reflected is determined and a normal vector is computed for at least one reflective vertex of the object; the normal vector is rotated into view-space and an environment map of the image to be reflected is computed using a reflection vector determined on the basis of the rotated normal vector; the opacity of the vertex is determined as a function of an angle between the viewpoint vector and the normal vector; the colors of the object are determined by blending its colors with the colors of the object's background as a function of the opacity; and the object and the environment map are drawn on the object by adding the color values of the environment map to the color values of the object.

### FIELD OF THE INVENTION

The present invention relates to computer graphics, and more particularly to creation of reflective image objects used in computer graphics.

### BACKGROUND OF THE INVENTION

A commonly used technique in rendering a three-dimensional (3D) scene to have a more realistic look is to apply textures on the surfaces of 3D objects. A texture can be defined as an ordinary two-dimensional image, such as a photograph, that is stored in a memory as an array of pixels (or texels, to separate them from screen pixels). Along with the increase in the quality of displays and display drivers as well as in the processing power of graphics accelerators used in computers, the demand for even better image quality in computer graphics also continues.

One challenge in improving the visual quality of images relates to reflective surfaces in image objects. If an image includes objects with a reflective surface, such as metal or glass, they should naturally reflect other objects of the image and light superimposed on the surface. Creating a natural and credible reflection into an image is computationally a demanding task, especially if the image includes moving objects and/or variable lighting conditions, i.e. if the image belongs, for example, to a video sequence.

Reflections on the reflective surfaces of image objects are typically created as textures. There are various computer graphics algorithms for rendering reflective surfaces, known as such, which algorithms include processes for mapping a bitmap image (i.e. a texture) of the object to be reflected onto a reflective surface and for calculating the highlights of the reflections. One of the most popular 3D graphics application programming interface (API) is called OpenGL (Open Graphics Library), which is widely used in various computer graphics applications. OpenGL provides versatile features for rendering, texture mapping, special effects, and other visualization functions. OpenGL also includes a feature for generating reflections using textures, i.e. glTexGen( ) function.

OpenGL and its features are, however, impose a computationally rather heavy burden when executed in devices with limited processing power, such as mobile stations and PDA devices. Therefore, there has been developed a dedicated version of OpenGL for embedded platforms, called OpenGL ES (Embedded systems). OpenGL ES is a lightweight version of the complete OpenGL with some embedded platform-specific extra functions, like programming of vertex and fragment shaders that are most commonly used in embedded platforms.

Since OpenGL ES has been developed in order to minimize the cost and power consumption of embedded programmable graphics subsystems, OpenGL ES lacks many of the features of OpenGL, for example the feature for generating reflections using textures. Moreover, as mentioned above, said glTexGen( ) function is not optimal for embedded devices with limited processing power. Accordingly, there exists a need for an alternative process for generating reflections, which process would be more suitable especially for embedded devices.

### SUMMARY OF THE INVENTION

Now there is invented an improved method and technical equipment implementing the method, by which an alternative and simplified process for generating reflections is achieved. Various aspects of the invention include a rendering method, a computer graphic system, an apparatus and a computer program for performing the generation of reflections, which aspects are characterized by what is described below. Various embodiments of the invention are disclosed in detail.

According to a first aspect, a method according to the invention is based on the idea of rendering reflections on surfaces of a three-dimensional object, the method comprising: determining at least one environment image to be reflected; computing a normal vector for at least one reflective vertex of the object; rotating the normal vector into view-space; computing an environment map of the image to be reflected using a reflection vector determined on the basis of the rotated normal vector; determining the opacity of the at least one vertex as a function of an angle between the viewpoint vector and the normal vector; drawing the object by blending its colors with the colors of the object's background as a function of the opacity; and drawing the environment map on the object by adding the color values of the environment map to the color values of the object.

According to an embodiment, said surfaces of the object are at least partly transparent, whereby the method further comprises: determining the opacity of the at least one vertex such that the opacity is low, when the angle between the viewpoint vector and the normal vector is small, and the value of the opacity increases as a function of the value of the angle.

According to an embodiment, the method further comprises: providing the view of the object with a front light source, placed in the upper left corner of the view, and a back light source, placed in the lower right corner of view, said back light source being dimmer and in different color than the front light source.

According to an embodiment, the method further comprises: generating a highlight on the object by calculating a dot product between a light vector and the normal vector of the at least one vertex and creating the highlight on said vertex only, if the light vector and the normal vector are substantially parallel.

According to an embodiment, the environment image to be reflected is a blurred and/or scaled-down version of an image or an element visible in the view.

According to an embodiment, said method is used to create a refraction of an image through a glass-like object, the method further comprising: adjusting the rotated normal vector of the at least one reflective vertex of the object; computing the environment map of the image to be reflected on the basis of the adjusted normal vector; drawing the environment map on the inner surface of the object's rear side; creating glass-like effects on the other sides of the object such that the sides not facing to the viewpoint are determined as substantially opaque and shaded with a dark color; and creating specular highlights on at least some of the vertices or polygons facing to the viewpoint.

According to an embodiment, the step of adjusting the rotated normal vector further comprises: calculating a first normal vector for a rounded vertex surface; calculating a second normal vector for a sharp-edged vertex surface; and averaging the values of the X and Y coordinates of the first and the second normal vector.

The rendering method according to the invention provides significant advantages. A major advantage is that the method enables the creation of visually impressive reflection effects with limited processing power and with a restricted set of rendering tools. For example, no shaders are required in modelling the final surface properties of an object, whereby a simpler platform and hardware can be utilized in the process. The use of metallic and glass surfaces improves the visual quality of the user interface. The reflective surfaces on the GUI can be designed to match the metallic surface of the device itself, thus improving apparent integration between hardware and software components. For example, one can display a metallic selection cursor that can be used to select icons from a list. A further advantage is that the rotation of the vertex normal provides the reflection coordinates, i.e. X and Y coordinates, and the opacity factor of the vertex, derived from the Z coordinate, with the one and same calculation. Moreover, the embodiment of producing inverse reflection provides very impressive glass-like effects of the object.

The further aspects of the invention include various apparatuses arranged to carry out the inventive steps of the above methods.

### BRIEF DESCRIPTION OF THE DRAWINGS

In the following, various embodiments of the invention will be described in more detail with reference to the appended drawings, in which

FIG. 1 shows a 3D computer graphics system according to an embodiment of the invention in a simplified block diagram;

FIG. 2 shows a dedicated 3D graphics processor according to an embodiment in a simplified block diagram;

FIG. 3 shows a flow chart of a method for rendering reflections on the reflective surfaces of a 3D object according to an embodiment;

FIG. 4 shows a flow chart of a method for creating an inverse reflection for glass-like object according to an embodiment; and

FIGS. 5a, 5b show some example images of the inverse reflection produced according to an embodiment.

### DESCRIPTION OF EMBODIMENTS

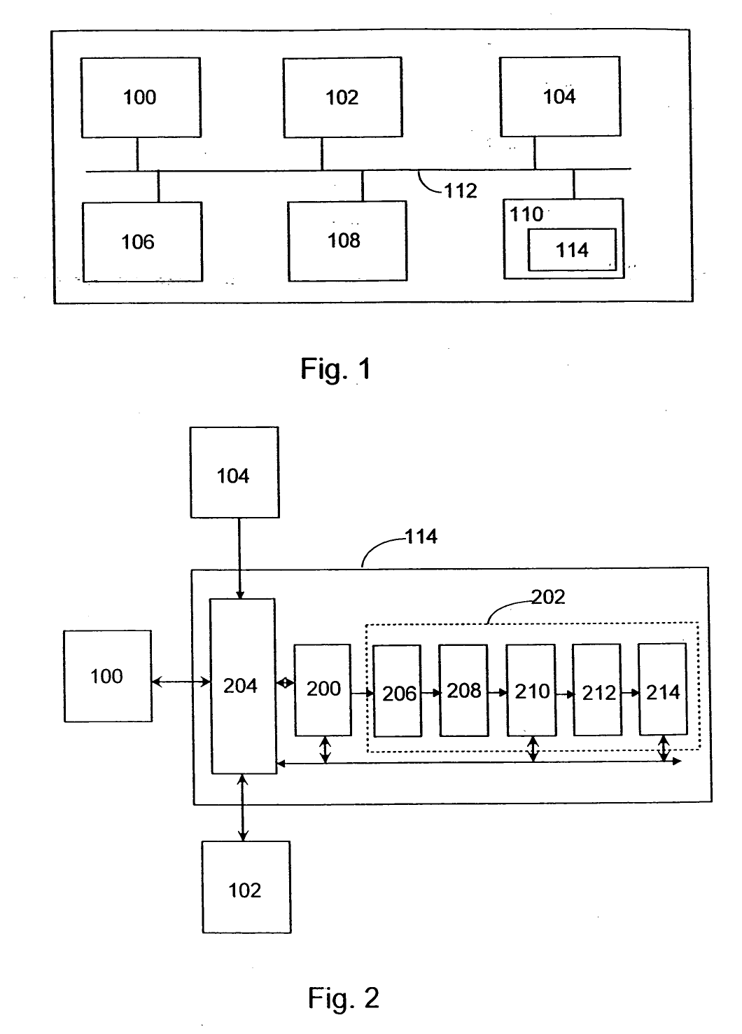

The structure of a 3D computer graphics system according to a preferred embodiment of the invention will now be explained with reference to FIG. 1. The structure will be explained in accordance with the functional blocks of the system. For a skilled man, it will be obvious that several functionalities can be carried out with a single physical device, e.g. all calculation procedures can be performed in a single processor, if desired. A data processing system of an apparatus according to an example of FIG. 1 includes a main processing unit 100, a memory 102, a storage device 104, an input device 106, an output device 108, and a graphics subsystem 110, which all are connected to each other via a data bus 112.

The main processing unit 100 is a conventional processing unit such as the Intel Pentium processor, Sun SPARC processor, or AMD Athlon processor, for example. The main processing unit 100 processes data within the data processing system. The memory 102, the storage device 104, the input device 106, and the output device 108 are conventional components as recognized by those skilled in the art. The memory 102 and storage device 104 store data within the data processing system 100. The input device 106 inputs data into the system while the output device 108 receives data from the data processing system. The data bus 112 is a conventional data bus and while shown as a single line it may be a combination of a processor bus, a PCI bus, a graphical bus, and an ISA bus. Accordingly, a skilled man readily recognized that the apparatus may be any conventional data processing device, like a computer device, a 3D video game terminal or a wireless terminal of a communication system, the device including 3D computer graphics system according to embodiments to described further below.

The main processing unit 100 interactively responds to user inputs, and executes a program, such as a video game, supplied, for example, by the storage device 104, such as an optical disk drive. As one example, in the context of video game play, main processing unit 100 can perform collision detection and animation processing in addition to a variety of interactive and control functions. The main processing unit 100 generates 3D graphics and audio commands and sends them to the graphics subsystem 110, including preferably a dedicated graphics and audio processor 114. The graphics and audio processor 114 processes these commands to generate desired visual images and deliver them via the output device 108, for example on a display. The apparatus preferably includes a video encoder, which receives image signals from graphics and audio processor 114 and converts the image signals into analog and/or digital video signals suitable for display on a standard display device, such as a computer monitor or a display screen of a portable device.

A dedicated 3D graphics processor according to an embodiment is further illustrated in a block diagram of FIG. 2. The 3D graphics processor includes, among other things, a command processor 200 and a 3D graphics pipeline 202. The main processing unit 100 communicates streams of data (e.g., graphics command streams and display lists) to the command processor 200 via a processor interface 204. The command processor 200 performs command processing operations that convert attribute types to floating point format, and pass the resulting complete vertex polygon data to the graphics pipeline 202 for 2D and/or 3D processing and rendering. The graphics pipeline 202 then generates images based on these commands.

The graphics pipeline 202 comprises various processing units operating parallel in order to achieve high efficiency, and these units may include, for example, a transform unit 206, a setup/rasterizer 208, a texture unit 210, a texture environment unit 212, and a pixel engine 214. The transform unit 206 performs a variety of 2D and 3D transform and other operations, e.g. transforming of incoming geometry per vertex from object space to screen space, transforming of incoming texture coordinates, computing projective texture coordinates, lighting processing and texture coordinate generation. The setup/rasterizer 208 includes a setup unit, which receives vertex data from transform unit 206 and sends triangle setup information to one or more rasterizer units performing various rasterization functions. The texture unit 210 performs various tasks related to texturing including, for example, retrieving textures from main memory 102, and a plurality of texture processing operations.

The texture unit 210 outputs filtered texture values to the texture environment unit 212 for texture environment processing. Texture environment unit 212 blends polygon and texture color/alpha/depth, and it also typically provides multiple stages to perform a variety of other interesting environment-related functions. The pixel engine 214 then combines mathematically the final fragment color, its coverage and degree of transparency with the existing data stored at the associated 2D location in the frame buffer to produce the final color for the pixel to be stored at that location. Output is a depth (Z) value for the pixel.

A skilled man appreciates that the above-described 3D computer graphics system is only one example of a platform, wherein the embodiments described below can executed. A suitable 3D computer graphics system can be implemented in various ways, and a separate 3D graphics processor, as described in FIG. 2, is not necessarily needed, even though in most cases it provides significant advantages in fostering the computation of 3D effects remarkably.

In 3D computer graphics, a three-dimensional virtual representation of objects is stored in the computer for the purposes of performing calculations and rendering images. The process of creating 3D computer graphics can be sequentially divided into three basic phases, namely modelling, scene layout setup, and rendering.

The modelling stage relates to shaping individual objects that are later used in the scene. There exist a number of modelling techniques, but many of the most popular modelling software are based on polygonal modelling. Modelling processes typically also include editing object surface or material properties (e.g., color, luminosity, diffuse and specular shading components, reflection characteristics, transparency or opacity, or index of refraction), adding textures and other features, etc. Modelling may also include various activities related to preparing a 3D model for animation. Objects may be fitted with a skeleton having the capability of affecting the shape or movements of that object. This aids in the process of animation in that the movement of the skeleton will automatically affect the corresponding portions of the model.

Modelling can be performed by means of a dedicated program, an application component or some scene description language. In 3D computer graphics, a shader is an application component of a program used to determine the final surface properties of an object or image. Many 3D graphics programs include vertex shaders. A vertex is a point in 3D space with a particular location, usually given in terms of its X, Y and Z coordinates, i.e. it is a manifestation of a triangle. A vertex shader, in turn, is an application component that is used to transform the attributes of vertices (points of a triangle), such as color, texture, position and direction, from the original color space to the display space, thus allowing the original objects to be distorted or reshaped in any manner. There are also light source shaders that calculate the color of the light emitted from a point on the light source towards a point on the surface being illuminated.

The output of a vertex shader along with texture maps goes to an interpolation stage and then to the pixel shader. The pixel shader is another programmable function that allows flexibility in shading an individual pixel. Whereas vertex shaders can be used to completely transform the shape of an object, pixel shaders are used to change the appearance of the pixels.

Scene setup involves arranging virtual objects, lights, cameras and other entities on a scene, which will later be used to produce a still image or an animation. Rendering is the final process of creating the actual 2D image or animation from the prepared scene, whereby several different, and often specialized rendering methods can be used. The rendering process is known to be computationally expensive, given the complex variety of physical processes being simulated.

It is generally known to use environment maps, sometimes referred to as reflection maps, for applying environment reflections to a curved surface. An environment map is typically created with the help of some shader language algorithm using vertex shaders and pixel shaders. An environment map relies on a reflection vector to sample the texture. The reflection vector leaves the point being textured at an angle from the normal that is equivalent to the angle between the view vector and the normal to the point.

According to an embodiment of the invention, the reflection bitmap, i.e. a texture, is mapped on the reflective surface of a 3D object with an environment mapping algorithm, which uses surface normals and a vector from the camera viewpoint towards the origin of the reflective object to generate the texture coordinates.

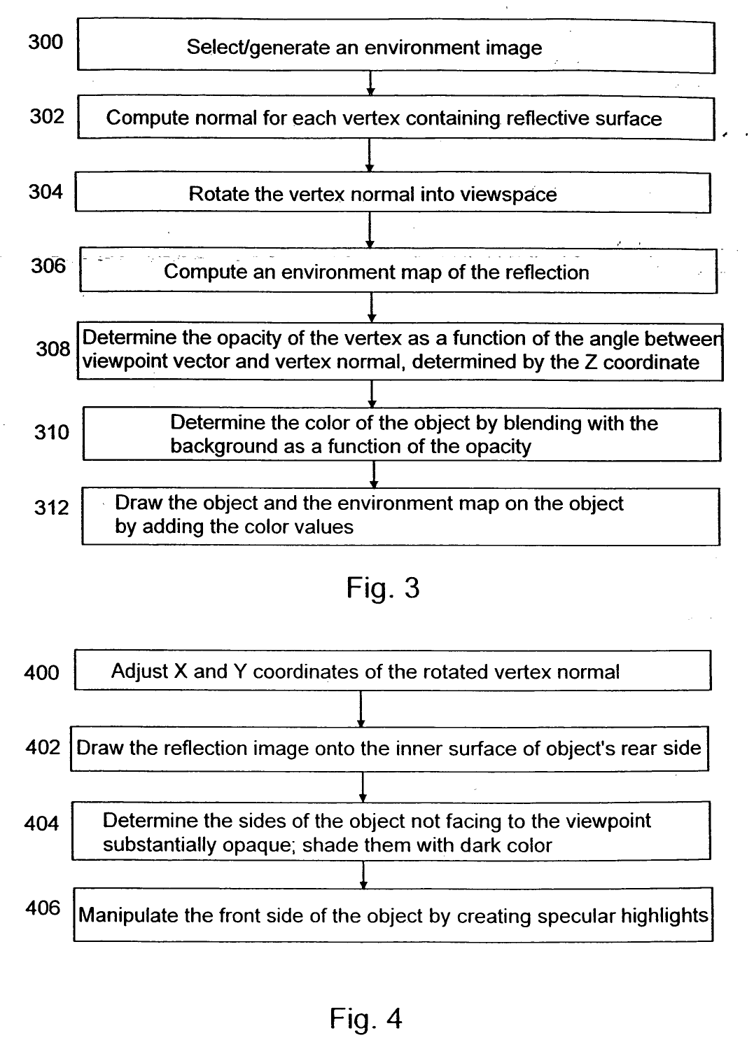

A method for rendering reflections on the reflective surfaces of a 3D object, as carried out according to an embodiment, is illustrated in the following by referring to the flow chart of FIG. 3. In the first phase, a two-dimensional image of the environment is selected or generated (300). This reflection image can be a scaled-down version of whatever is visible on the display, for example a background image. Scaling down an image is a convenient way to produce a blurred version of the image. If necessary, the scaled-down image can be further subjected to blurring filtering to provide smoother blurring. The reflection image can also be something else shown on the display, e.g., the currently selected icon.

Then, for each polygon vertex that contains a reflective object, the normal is computed (302) at the location on the surface of the object. Naturally, the computation can also be carried out per-pixel-basis, but this is computationally much heavier and not very feasible in embedded devices. After the normal has been calculated for a particular vertex, it is rotated (transformed) into view-space (304), whereby the X and Y coordinates determine the reflection coordinates and the Z coordinate can be further utilized in determining the opacity of the surface.

A reflection vector is computed for the vertex using the normal, and the reflection vector is then used to compute an approximation of the reflection image (environment map) that represents the objects in the reflection direction (306). In order to generate specular highlights on the object, the view must be provided with a light source. According to an embodiment, there are preferably provided two simulated light sources: a front light and a back light. The front light can preferably be placed in the upper left corner of the display, whereby it corresponds to the light direction commonly used in 2D graphical user interfaces (GUIs). The back light, which may preferably be dimmer and different color, e.g. blue, than the front light, may then be placed in the opposite direction. Thus, when calculating a dot product for the vertex, the amount of both the front light and the back light is provided by the same function, and the highlight effect can be drawn at the same time when drawing the environment map. A positive value of the dot product denotes for front light for the particular vertex and a negative value of the dot product means back light.

Even though the above method for providing highlights is computationally efficient, it has the drawback that due to the brightness of the highlight effect, it may become invisible with bright environment maps. According to an embodiment, a simplified method to generate a sharper, glasslike highlight is to use an environment map, wherein the light sources are pre-drawn on the map (texture). In this embodiment, the number, the color and the position of the light sources can be freely chosen. In the method, the dot product between the light vector and the surface normal vectors is calculated and it is manipulated with a function so that only when the light vector and the surface normal vector are almost parallel, the light strongly affects the surface. This is faster than calculating a proper highlight, because the single calculation of the dot product enables to determine the amount of light and the intensity of the approximated specular highlight. It is also possible to darken the surface, instead of highlighting it, thus enabling visualization of further reflections, e.g. a dark rectangular reflection from the bottom of the display towards the viewer.

Now, for a surface having slight reflection combined with a degree of opacity, e.g. a glass-like surface, the Z coordinate of the rotated vertex normal is utilized in determining the opacity of the surface. According to an embodiment, the opacity of a particular vertex in the 3D object is controlled according to the angle between the viewpoint vector towards the origin of the object and the surface normal vector (308), determined by the Z coordinate. If the surface normal is parallel with the viewpoint vector (looking straight through the surface), the opacity of the vertex is low and the background is clearly visible through the object. If there is a significant angle between the viewpoint vector and the surface normal (the surface is tilted), the opacity is higher and the background is less visible. The light vector determined on the basis of the simulated light sources also affects the opacity so that vertices that are affected by the simulated specular highlight are nearly opaque.

Before the object is drawn, the color values determined by the color of the object are first blended with the background using the opacity as the blending factor (310). The result is, for example in the case of a sphere, that the center of the sphere is translucent while the edges are closer to the color of the glass material itself (e.g. gray).

Finally, the reflective object and the reflection bitmap to be drawn on it are drawn concurrently (312) by adding the color values from the reflection bitmap to the color values produced in the previous step. The strength of the reflection can be adjusted by selecting an appropriate color when drawing the reflection. For example, if a 10% gray color is used when drawing the reflection, the color values are scaled by 0.1 before adding them to the pixel values produced by the previous step.

A skilled man readily appreciates that when the reflective object has a highly reflective surface, i.e. a mirror-like surface or a metallic surface, which produces a mirror-like reflection, the opacity of the surface need not be taken into account as described above. In case of a highly reflective vertex surface, it can be determined, for example, that the function controlling the opacity of the vertex receives a predetermined constant value for all values of the angle between the viewpoint vector towards the origin of the object and the surface normal vector determined by the Z coordinate. The constant value preferably sets the opacity of the vertex as opaque or at least nearly opaque. Then the above process is simplified such that the reflection bitmap is mapped onto the surface with the environment mapping algorithm as described above. The light sources can also be configured as described above. Finally, when drawing the object, the color values from the texture are summed with the color values from the light sources.

It should be noted that the environment mapping algorithm used in the above process is not limited by any means, but any suitable environment mapping algorithm, like the OpenGL function glTexGen( ) can be used, if available. In platforms where such a function is not available, like in OpenGL ES, the coordinates have to be calculated in their own dedicated process. In the previous examples, the processes of the reflection effects are designed such that they favor faster performance to physical accuracy. It is, however, an advantage of the above process that no shaders are required in modelling the final surface properties of an object, whereby a simpler platform and hardware, typically available in embedded devices, can be utilized in the process.

The blurred reflection image seen in a reflective surface can be chosen in a number of ways. If a background image is being displayed on the reflective surface, the reflection can be a down-sampled and blurred version of the background image. If a thumbnail version of the background image exists, it can be used as the blurred version of the image. If there is some other distinctive element shown on the display, e.g., the currently selected icon, it can be used as the reflection bitmap.

According to an embodiment, if a movie clip is being displayed, the blurred version of each frame can be a down-sampled version of the frame. The down-sampled version can be simply produced such that the width and height of the frame is divided by some factor, e.g., 4 or 8.

According to an embodiment, if the background is being generated at runtime, a down-sampled version of the background image can be drawn into a separate memory buffer. An example of such a buffer is an EGL pbuffer rendering target used in OpenGL ES. The width and height of the memory buffer can be determined by dividing the width and height of the original background by an appropriate factor, e.g. by 4 or 8.

According to an embodiment, a highlight can be added to the blurred version of the background image. Since neither the background nor the front light is moving, the highlight can be held in one place and still look natural.

The advantages provided by the embodiments are apparent to a skilled person. A major advantage is that the method enables to create visually impressive reflection effects with limited processing power and with a restricted set of rendering tools.

The use of metallic and glass surfaces improves the visual quality of the user interface. The reflective surfaces on the GUI can be designed to match the metallic surface of the device itself, thus improving apparent integration between hardware and software components. For example, one can display a metallic selection cursor that can be used to select icons form a list. A further advantage is that the rotation of the vertex normal provides the reflection coordinates, i.e. X and Y coordinates, and the opacity factor of the vertex, derived from the Z coordinate, with the one and same calculation.

A further visual effect, which provides an impressive glass-like sensation of the object, is called inverse reflection. It is an effect that simulates refraction of light such that a reflected image is drawn onto the inner surface of the object's rear side. A further embodiment, depicted in FIG. 4, illustrates the steps of creating the inverse reflection.

The procedure of producing the inverse reflection starts by drawing an environment mapping of reflection image onto the inner surface of the object's rear side. In this stage, the front side of the object is considered transparent. In order to produce a more realistic effect of the refraction of light, the X and Y coordinates of the rotated vertex normal needs to be adjusted (400).

According to an embodiment, the adjustment is carried out by calculating at least two normal vectors for each vertex, rotating them into the viewspace, and then averaging the values of the rotated X and Y coordinates. A first normal vector is preferably calculated for a completely rounded vertex surface and a second normal vector is preferably calculated for a sharp-edged vertex surface. The rounded vertex surface denotes for a vertex having a surface normal calculated as an average (weighted or unweighted) of the surface normals of the polygons having said vertex as a corner point. The sharp-edged vertex surface, in turn, denotes for a vertex having a surface normal substantially equal to the surface normal of the polygon having said vertex as a corner point. If, for some reason, it is possible to calculate only one surface normal per vertex, then the surface normal belonging to the polygon having largest surface area is selected as a reference point. The average values of the X and Y coordinates of the first and the second rotated normal vectors then enable the computation of an approximation of the reflection image (environment map), which resembles a very natural refraction of light through an object of glass.

According to an embodiment, if the object of glass is moving on the display, the averaged X and Y coordinates can be further adjusted by adding an offset to the coordinate values according to the movement of the object. This enables to further simulate the changes of refraction, which are caused by the movements of the object.

Once the reflection image simulating the refraction of light has been drawn onto the inner surface of the object's rear side, glass-like effects are introduced in the other sides of the object (402). Again, the Z coordinate of the vertex normal is utilized in that the vertices whose Z coordinate is substantially perpendicular to the viewpoint vector, i.e. the sides of the object which are not facing to the viewpoint, are determined nearly or completely opaque and shaded with a dark color (404), such as black. This way the outer boundaries of the object become distinctive and the attention of an observer is paid on the refraction image inside the object.

Finally, the front side of the object and other possible surfaces facing towards the viewpoint are manipulated (406) by applying an approximated environmental mapping to the respective vertices, whereby specular highlights are created on such surfaces. The specular highlights provide reflections of the light source on the front surface of the object, thus simulating light reflections from a transparent glass surface. Furthermore, since the object now includes vertices, which are shaded dark, and also vertices having bright specular highlight, the object is visible even if the background is totally black or totally white. An object with only conventional reflections mapped on its surfaces could become invisible, if placed on a totally black or totally white background.

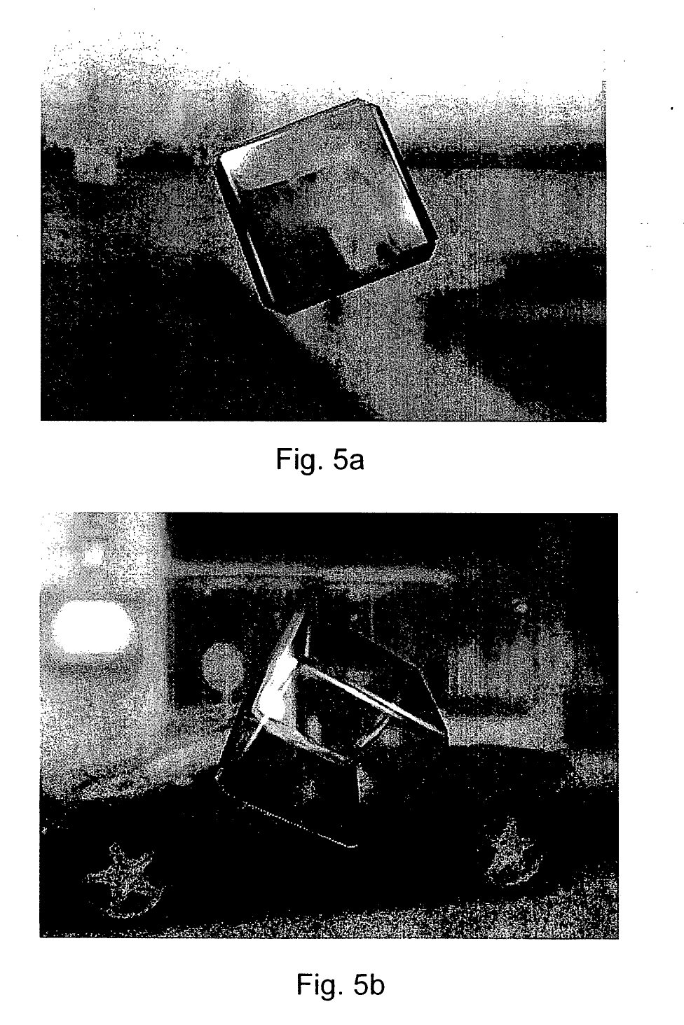

Some examples of glass-like objects, wherein an inverse reflection is created, are shown in FIGS. 5a and 5b. In FIG. 5a, a ship and towers on the background of the image are reflected through the glass cube such that a blurred and scaled-down version of the ship and the towers are drawn onto the inner surface of the glass cube's rear side. The sides of the cube not facing towards the viewpoint are made opaque and shaded with dark color. Some specular highlights are created on surfaces facing towards the viewpoint. Likewise in FIG. 5b, windows on the background of the image are reflected through the glass cube such that a blurred and scaled-down version of the windows is drawn onto the inner surface of the glass cube's rear side. Again, the sides of the cube not facing towards the viewpoint are made opaque and shaded with dark color. As can be seen in FIGS. 5a and 5b, the above-described embodiment of producing inverse reflection provides a very impressive glass-like sensation of the glass cube.

The steps according to the embodiments can be largely implemented with program commands to be executed in the processing unit of a data processing device operating as a 3D graphics processing apparatus. Thus, said means for carrying out the method described above can be implemented as computer software code. The computer software may be stored into any memory means, such as the hard disk of a PC or a CD-ROM disc, from where it can be loaded into the memory of the data processing device. The computer software can also be loaded through a network, for instance using a TCP/IP protocol stack. It is also possible to use a combination of hardware and software solutions for implementing the inventive means.

It should be realized that the present invention is not limited solely to the above-presented embodiments, but it can be modified within the scope of the appended claims.

1. A method of computer graphics for rendering reflections on surfaces of a three-dimensional object, the method comprising:
determining at least one environment image to be reflected;
computing a normal vector for at least one reflective vertex of the object;
rotating the normal vector into view-space;
computing an environment map of the image to be reflected using a reflection vector determined based on the normal vector rotated into view-space;
determining opacity of the at least one reflective vertex as a function of an angle between a viewpoint vector and the normal vector;
determining color values of the object by blending colors of the object with colors of a background of the object as a function of the opacity; and
drawing the object and the environment map on the object by adding color values of the environment map to the color values of the object.

2. The method according to claim 1, wherein said surfaces of the three-dimensional object are at least partly transparent, the method further comprising:
determining the opacity of the at least one vertex such that a value of the opacity is low when a value of the angle between the viewpoint vector and the normal vector is small, and the value of the opacity increases as a function of the value of the angle.

3. The method according to claim 1, the method further comprising:
providing a view of the object with a front light source, placed in an upper left corner of the view, and a back light source, placed in a lower right corner of view, said back light source being dimmer and in a different color than the front light source.

4. The method according to claim 1, the method further comprising:
providing light sources pre-drawn on the environment map; and
generating a highlight on the object by calculating a dot product between a light vector and the normal vector of the at least one vertex and creating the highlight on said vertex only if the light vector and the normal vector are substantially parallel.

5. The method according to claim 4, further comprising:
determining vertices on which the highlight has been provided nearly opaque.

6. The method according to claim 1, wherein the step of drawing the environment map on the object further comprises:
adjusting a strength of a reflection by selecting a color for the environment map.

7. The method according to claim 1, wherein an environment image to be reflected is a blurred and scaled-down version of an image or an element visible in a view of the object.

8. The method according to claim 7, wherein said method is applied in connection with a video sequence having frames, the method further comprising:
down-sampling each frame of the video sequence by dividing a width and a height of the frame by an appropriate factor; and
using a down-sampled version of the frame as the blurred and scaled-down version of the image to be reflected.

9. The method according to claim 7, further comprising:
generating the background image of the object at runtime; and
storing a down-sampled version of the background image in a separate buffer memory, said down-sampled version being generated by dividing a width and a height of the image by an appropriate factor.

10. The method according to claim 9, further comprising:
creating a highlight on the down-sampled version of the background image.

11. The method according to claim 1, wherein said method is used to create a refraction of an image through a glass-like object, the method further comprising:
adjusting a rotated normal vector of the at least one reflective vertex of the object;
computing the environment map of the image to be reflected based on an adjusted normal vector;
drawing the environment map on a inner surface of a rear side of the object;
creating glass-like effects on other sides of the object such that sides not facing to a viewpoint are determined as substantially opaque and shaded with a dark color; and
creating specular highlights on at least some vertices or polygons facing a viewpoint.

12. The method according to claim 11, wherein the step of adjusting the rotated normal vector further comprises:
calculating a first normal vector for a rounded vertex surface;
calculating a second normal vector for a sharp-edged vertex surface; and
averaging values of rotated X and Y coordinates of the first normal vector and the second normal vector.

13. The method according to claim 12, wherein the glass-like object is moving in a view, whereby the step of adjusting the rotated normal vector further comprises:
adding an offset to the values of the X and Y coordinates according to movement of the object.

14. The method according to claim 11, wherein the sides not facing to the viewpoint are determined as comprising vertices having a Z coordinate of the normal vector substantially perpendicular to the viewpoint.

15. A computer graphics system for rendering reflections on surfaces of a three-dimensional object, the system comprising:
means for determining at least one environment image to be reflected;
means for computing a normal vector for at least one reflective vertex of the object;
means for rotating the normal vector into view-space;
means for computing an environment map of the image to be reflected using a reflection vector determined based on the normal vector rotated into view-space;
means for determining opacity of the at least one reflective vertex as a function of an angle between a viewpoint vector and the normal vector;
means for determining color values of the object by blending colors of the object with colors of a background of the object as a function of the opacity; and
means for drawing the object and the environment map on the object by adding color values of the environment map to the color values of the object.

16. The system according to claim 15, wherein said surfaces of the three-dimensional object are at least partly transparent, and the system is arranged to
determine the opacity of the at least one vertex such that a value of the opacity is low when a value of the angle between the viewpoint vector and the normal vector is small, and the value of the opacity increases as a function of the value of the angle.

17. The system according to claim 15, wherein the system is arranged to
provide a view of the object with a front light source, placed in an upper left corner of the view, and a back light source, placed in a lower right corner of view, said back light source being dimmer and in a different color than the front light source.

18. The system according to claim 17, wherein the system is arranged to
providing light sources are pre-drawn on the environment map; and
generate a highlight on the object by calculating a dot product between a light vector and the normal vector of the at least one vertex and creating the highlight on said vertex only if the light vector and the normal vector are substantially parallel.

19. The system according to claim 18, further comprising:
means for determining vertices on which the highlight has been provided nearly opaque.

20. The system according to claim 15, wherein the means for drawing the environment map on the object are arranged to adjust a strength of a reflection by selecting a color for the environment map.

21. The system according to claim 15, wherein an environment image to be reflected is a blurred and scaled-down version of an image or an element visible in a view of the object.

22. The system according to claim 15, the system being arranged to create a refraction of an image through a glass-like object, the system further comprising:
means for adjusting a rotated normal vector of the at least one reflective vertex of the object;
means for computing the environment map of the image to be reflected based on an adjusted normal vector;
means for drawing the environment map on an inner surface of a rear side of the object;
means for creating glass-like effects on other sides of the object such that sides not facing to a viewpoint are determined as substantially opaque and shaded with a dark color; and
means for creating specular highlights on at least some vertices or polygons facing a viewpoint.

23. The system according to claim 22, wherein the means for adjusting the rotated normal vector are arranged to:
calculate a first normal vector for a rounded vertex surface;
calculate a second normal vector for a sharp-edged vertex surface; and
average values of rotated X and Y coordinates of the first normal vector and the second normal vector.

24. The system according to claim 23, wherein the glass-like object is moving in a view, whereby the means for adjusting the rotated normal vector are further arranged to add an offset to the values of the X and Y coordinates according to movement of the object.

25. The system according to claim 22, wherein the sides not facing to the viewpoint are determined as comprising vertices having a Z coordinate of the normal vector substantially perpendicular to the viewpoint.

26. An electronic device comprising a computer graphics system for rendering reflections on surfaces of a three-dimensional object, the system comprising:
means for determining at least one environment image to be reflected;
means for computing a normal vector for at least one reflective vertex of the object;
means for rotating the normal vector into view-space;
means for computing an environment map of the image to be reflected using a reflection vector determined based on the normal vector rotated into view-space;
means for determining opacity of the at least one reflective vertex as a function of an angle between a viewpoint vector and the normal vector;
means for determining color values of the object by blending colors of the object with colors of a background of the object as a function of the opacity; and
means for drawing the object and the environment map on the object by adding color values of the environment map to the color values of the object; and the electronic device further comprising
a display, functionally connected to the computer graphics system, for displaying said object.

27. A computer program product, stored on a computer readable medium and executable in a data processing device, for rendering reflections on surfaces of a three-dimensional object, the computer program product comprising:
a computer program code section for determining at least one environment image to be reflected;
a computer program code section for computing a normal vector for at least one reflective vertex of the object;
a computer program code section for rotating the normal vector into view-space;
a computer program code section for computing an environment map of the image to be reflected using a reflection vector determined based on the normal vector rotated into views space;
a computer program code section for determining opacity of the at least one reflective vertex as a function of an angle between a viewpoint vector and the normal vector;
a computer program code section for determining color values of the object by blending colors of the object with colors of a background of the object as a function of the opacity; and
a computer program code section for drawing the object and the environment map on the object by adding color values of the environment map to the color values of the object.

28. The computer program product according to claim 27, wherein said surfaces of the three-dimensional object are at least partly transparent, the computer program product further comprising:
a computer program code section for determining the opacity of the at least one vertex such that a value of the opacity is low when a value of the angle between the viewpoint vector and the normal vector is small, and the value of the opacity increases as a function of the value of the angle.
